(19) United States
(12) Patent Application Publication
(10) Pub. No.: US 2014/0359374 A1
(43) Pub. Date: Dec. 4, 2014

(54) SYSTEM AND METHOD FOR MANAGING TRACE DATA IN A PORTABLE COMPUTING DEVICE

(71) Applicant: Qualcomm Incorporated, San Diego, CA (US)

(72) Inventors: MARTYN RYAN SHIRLEN, RALEIGH, NC (US); VICTOR WONG, SAN DIEGO, CA (US)

(21) Appl. No.: 13/909,063

(22) Filed: Jun. 3, 2013

(51) Int. Cl. G06F 11/34

(52) U.S. Cl. CPC G06F 11/3466
USPC 714/45

(57) ABSTRACT

Systems, methods, and computer programs for managing trace data in a portable computing device are disclosed. One system includes a system-on-chip and a trace parser. The system-on-chip may have a plurality of trace sources for originating corresponding trace data and a trace system configured to receive and dump the trace data from one of the trace sources to a plurality of trace sinks. The trace parser is configured to reconstruct the trace data dumped to the plurality of trace sinks.

### DESCRIPTION OF THE RELATED ART

System-on-chip (“SoC”) designs, which are incorporated into portable computing devices, are getting more complex, frequently with more and more processors to perform different functionality and meet the increasing demands for such devices. SoCs typically include a trace infrastructure for recording and analyzing data about program execution for purposes of debugging and/or monitoring the execution of computer programs or diagnosing problems with software. The trace infrastructure generally comprises one or more trace sources that originate data related to the execution of programs embodied in hardware and/or software components residing on the SoC. The trace data is sent to one or more trace sinks residing off-chip or a trace buffer. The trace sinks may have associated files or memory components (i.e., trace dumps) for storing or dumping the trace data for subsequent processing and analysis by a trace parser.

Existing SoC trace solutions are limited, however, to choosing between high bandwidth on-chip trace capture resources (which typically have limited capacity) and relatively lower bandwidth off-chip resources.

Thus, there is a need in the art for improved mechanisms for managing SoC trace data in a portable computing device.

### SUMMARY OF THE DISCLOSURE

Systems, methods, and computer programs are disclosed for managing trace data in a portable computing device. An embodiment of a method for managing trace data in a portable computing device comprises: configuring trace data from a single trace source on a system-on-chip for trace capture at a plurality of trace sinks; sending the trace data from the single trace source to the plurality of trace sinks; and; reassembling the trace data originated by the single trace source from the plurality of trace sinks.

An embodiment of a system for managing trace data in a portable computing system comprises a system-on-chip and a trace parser. The system-on-chip comprises a plurality of trace sources for originating corresponding trace data and a trace system configured to receive and dump the trace data from one of the trace sources to a plurality of trace sinks. The trace parser is configured to reconstruct the trace data dumped to the plurality of trace sinks.

Another embodiment comprises a computer program for managing trace data in a portable computing device. The computer program is embodied in a computer-readable medium for execution by a processor. The computer program comprises logic configured to: configure trace data from a single trace source on a system-on-chip for trace capture at a plurality of trace sinks; send the trace data originated from the single trace source to the plurality of trace sinks; and reassemble the trace data originated by the single trace source from the plurality of trace sinks.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a block diagram illustrating an embodiment of a system for managing trace data in a portable computing device.

FIG. 2 is a block/flow diagram illustrating an embodiment of the architecture and operation of system of FIG. 1 for enabling single trace source dumping to a plurality of trace sinks.

FIG. 3 is a flowchart illustrating an embodiment of a method for managing trace data in the system of FIGS. 1 and 2.

FIG. 4 is a data diagram illustrating an embodiment of a periodic trace control packet for enabling single trace source dumping to a plurality of trace sinks.

FIG. 5 is a block/flow diagram illustrating an embodiment of the operation of the trace reassembly module for reassembling single trace data dumped to two or more trace dumps.

FIG. 6 is a block/flow diagram illustrating the architecture and operation of the trace reassembly module.

FIG. 7 is a block diagram illustrating an exemplary portable computing device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application or module running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

A “portable computing device” (“PCD”) may comprise, for example, a cellular telephone, a satellite telephone, a pager, a personal digital assistant, a smart phone, a navigation device, a smart book or electronic reader, a media player, a tablet computer, a laptop computer, or other such devices.

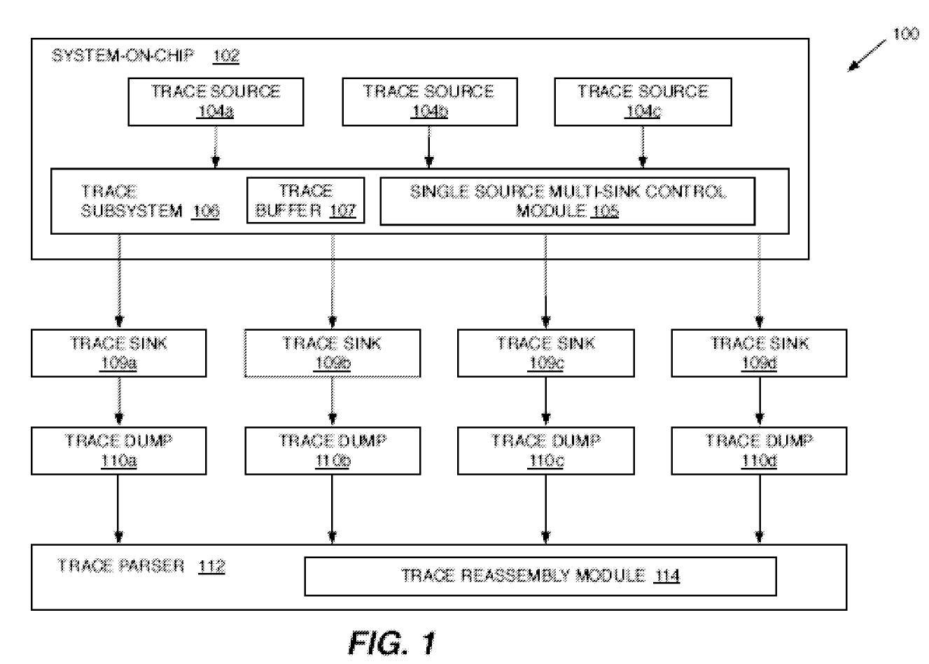

FIG. 1 is a system 100 that may be incorporated in, for example, a PCD for managing trace data originated by one or more trace sources 104a, 104b, and 104c. As known in the art, the process of tracing refers to recording and analyzing data about program execution for purposes of debugging and/or monitoring the execution of computer programs or diagnosing problems with software. System 100 comprises a system-on-chip (SoC) 102, which includes the one or more trace sources 104a, 104b, and 104c and a trace infrastructure (e.g., trace subsystem 106) for managing the tracing process. The trace sources 104a, 104b, and 104c originate data related to the execution of programs embodied in hardware and/or software components residing on the SoC 102. The trace data is received by the trace subsystem 106 and sent to one or more trace sinks 109a, 109b, 109c, and 109d residing off-chip or a trace buffer 107. The trace sinks 109a, 109b, 109c, and 109d may have associated files or memory components (i.e., trace dumps 110a, 110b, 110c, and 110d, respectively) for storing or dumping the trace data for subsequent processing and analysis by a trace parser 112.

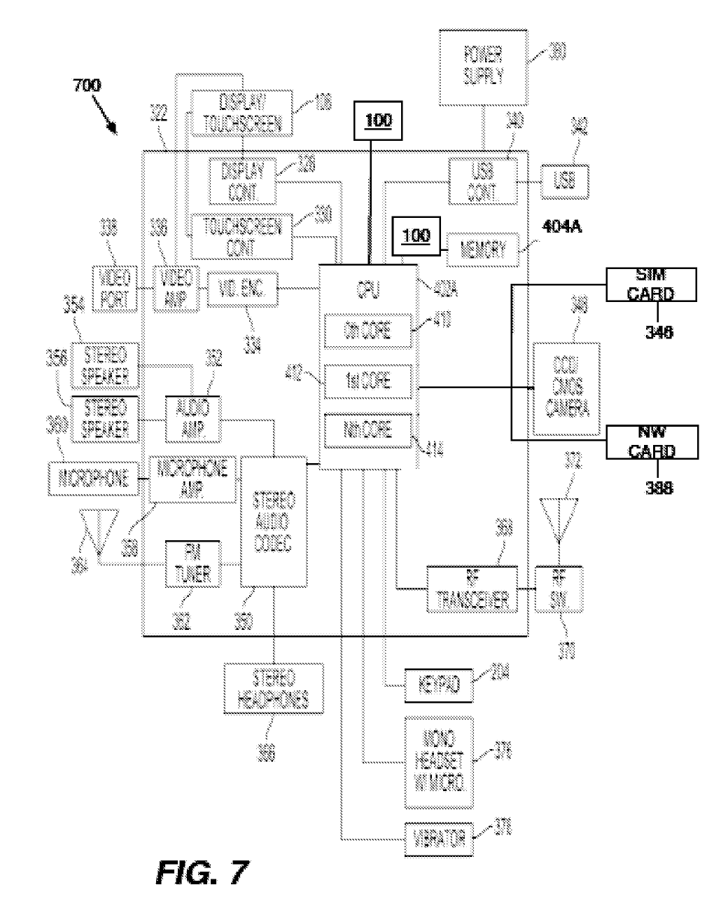

SoC 102 may support any desirable architecture (e.g., ARM) and may include various hardware and/or software components to perform different functionality (e.g., central processing units (CPUs), digital signal processors (DSPs), etc. FIG. 7 illustrates an exemplary PCD that incorporates the system 100. As mentioned above, SoC designs are getting more complex, frequently including more and more processors to perform different functionality. It should be appreciated that the architecture and operation of the SoC 102 may vary depending on the desired functionality, the type of PCD incorporating the SoC 102, and other design considerations. In this regard, the specific hardware, software, pin configurations, etc. on the SoC 102 and the other components illustrated in FIG. 1 may be varied as desired.

In an embodiment of system 100, CPUs, DSPs, and other hardware/software components on the SoC 102 may support trace units capable of outputting out-of-order (“000”) gigabits per second (“Gbps”) of trace data under normal operation in a PCD. Some processors (e.g., Krait processors) may provide up to 8 Gbps of trace data. As known in the art, CPU and other traces are not that useful if traces are made to send data to a trace sink 109 that is not equipped to handle its bandwidth. For example, a Krait processor (or other high bandwidth trace source 104) attempting to trace over to a trace port interface unit (“TPIU”) to Trace32 may experience bandwidth mismatch. As understood by one of ordinary skill in the art, the trace subsystem 106 may support “Trace32”, which refers to a conventional hardware assisted debug tool for embedded systems, such as, SoC 102. TPIU is a parallel trace interface used in ARM-based ecosystems and is one of many possible examples of trace interfaces that may be used. In conventional systems, a trace sink 109 typically cannot handle its bandwidth when lots of trace data is lost due to the bandwidth mismatch, which results in “gray areas” or unknown boxes on the Trace32 trace window. For this reason, high bandwidth traces are almost entirely relegated to be captured in a high bandwidth capable trace sink, such as trace buffer 107.

However, on-chip trace capture resources are significantly limited relative to off-chip capture resources (often on the order of kilobytes (“kB”) for on-chip versus Megabyte (“MB”) or Gigabyte (“GB”) for off-chip). Furthermore, external trace sinks (e.g., trace sinks 109a, 109b, 109c, and 109d) are typically limited in bandwidth. TPIU is typically limited to approximately 4-5 Gbps in a 16 data pin, 150 MHz double data rate (DDR) configuration. Other external trace sinks, such as universal serial bus 3 (USB3) is typically limited to approximately 3 Gbps. While these limitations have been addressed by, for example, adding pins to the SoC 102 or increasing the frequency on trace sinks, such as, TPIU, this comes at the expense of SoC design complexity and costs.

To address these and other disadvantages of conventional SoC tracing solutions, the system 100 further comprises a single source multi-sink control module 105 located on the SoC 102 and a trace reassembly module 114 integrated with the trace parser 112. It should be appreciated that system 100 comprises an improved trace management solution that provides a fully-scalable means of leveraging existing SoC trace sinks 109 without adding SoC pins and/or increasing interface frequencies while also allowing reduction of on-die trace capture storage. The system 100 may also allow reduction of external trace interface pin count for dedicated trace interfaces, such as, TPIU.

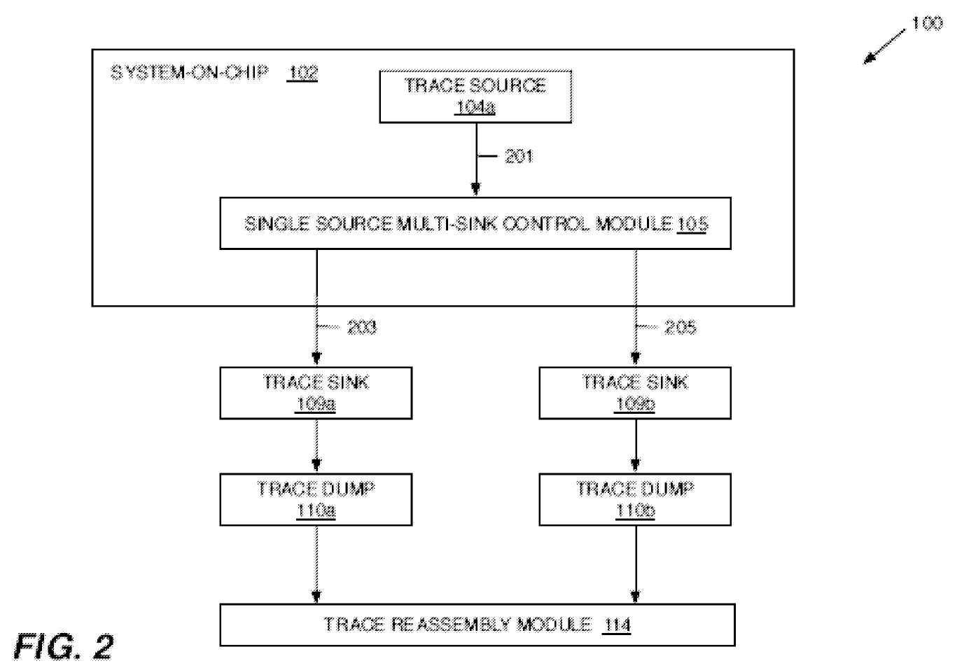

As illustrated in FIG. 2, the single source multi-sink control module 105 enables single trace source dumping to two or more trace sinks 109. Referring to the example of FIG. 2, trace data from a single trace source 104a (e.g., an ARM-based CPU, such as, the Krait™ brand processor) may be sent to two or more trace sinks 109a and 109b. The trace data is provided to the single source multi-sink control module 105 via an interface 201. The single source multi-sink control module 105 may be configured to programmatically divide trace bandwidth, as desired, by providing a first portion of the trace data from the single trace source 104a to a first trace sink 109a, via an interface 203, and a second portion of the trace data to a second trace sink 109b, via an interface 205. The first portion of the trace data may be stored in a first trace dump 110a and the second portion stored in a second trace dump 110b. As described below in more detail, various interleaving schemes may be incorporated by a trace protocol stack supported by the trace subsystem 106 for enabling the trace reassembly module 114 to reassemble, reconstruct, or de-interleave the trace data originated by the single trace source 104a and separately captured by the two or more trace sinks 109a and 109b.

It should be appreciated that single trace source dumping to two or more trace sinks 109 may provide various design and operational advantages. For instance, reassembling the single trace source 104a trace data from multiple trace dumps 110a and 110b, may allow for reduction of trace buffer resources (e.g., on-chip embedded trace buffer (ETB) resources in ARM ecosystems) because the trace buffer may be the highest bandwidth sink available. Furthermore, two or more trace interfaces may be combined using the single source multi-sink control module 105 to provide an increased bandwidth solution for a single trace source 104a that is currently unavailable in existing solutions. The ability to use external trace storage (e.g., trace dumps 110a and 110b) in lieu of a trace buffer for high bandwidth capture may provide improved storage capacity and permit more data intensive, frequent, and/or longer duration trace capture from a single trace source 104a.

Additional benefits may include the ability to reduce pin count and/or frequency of existing dedicated trace interfaces. A combination of dedicated and/or non-dedicated traces may provide single source high bandwidth tracing, which may enable a reduction of SoC pins and/or frequency. In an embodiment, system 100 may combine existing trace interfaces (e.g., a Krait™ brand processor trace to TPIU, USB, Peripheral Component Interconnect Express (“PCIe”), etc. In this regard, it should be appreciated that that trace sinks 109 may incorporate any desirable trace interfaces, trace sinks, trace dumps, etc. including those mentioned above, debugger applications, and memory, such as, double data rate (DDR) memory devices.

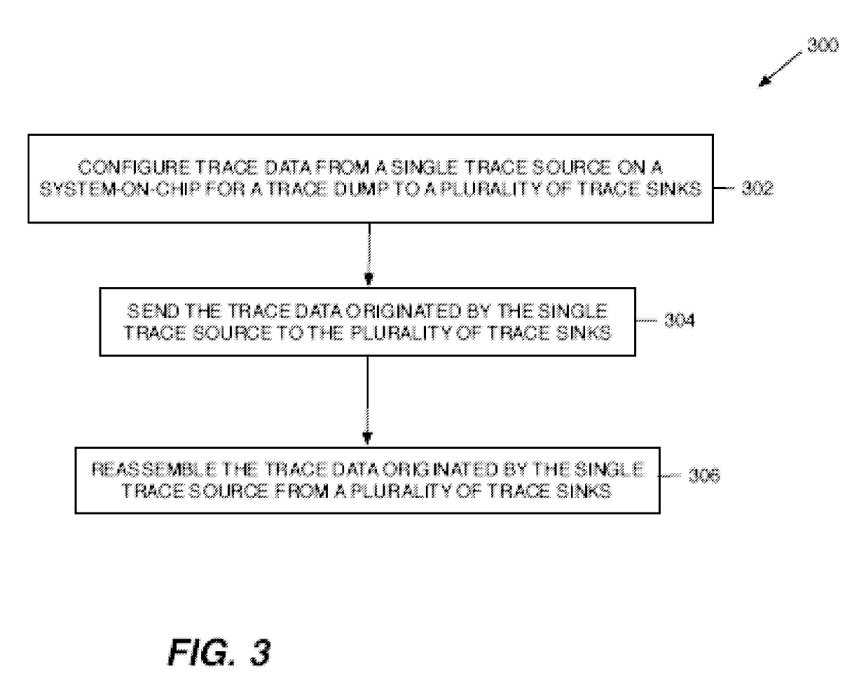

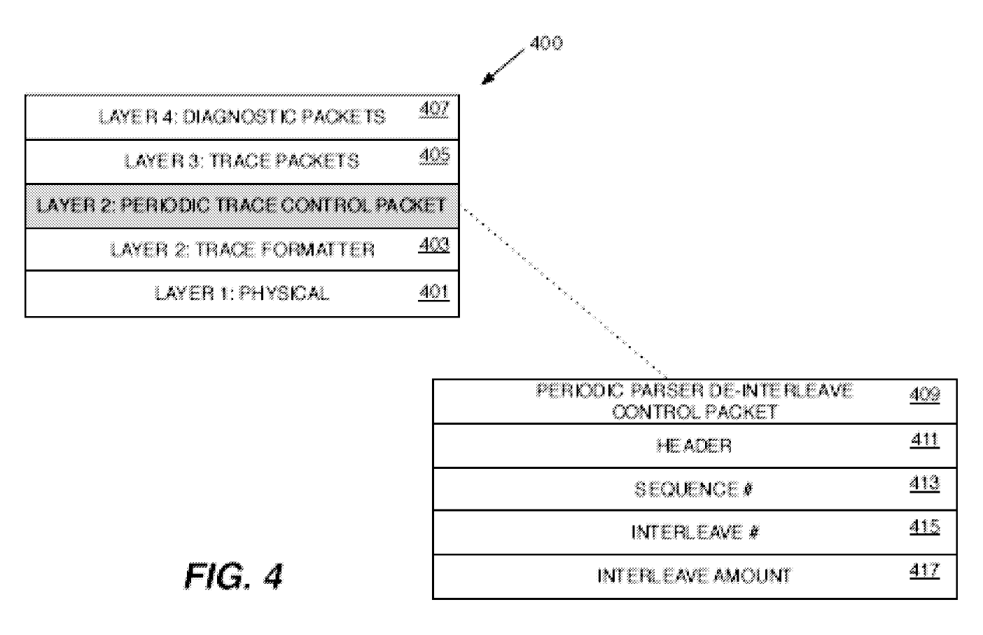

FIG. 3 illustrates an embodiment of a method 300 implemented by one or more of the components of system 100 for managing trace data. At block 302, trace data from a single trace source 104a on SoC 102 is configured for a trace dump to a plurality of trace sinks 109. In an embodiment, a trace protocol stack 400 (FIG. 4) may be implemented. As known in the art, the trace protocol stack 400 may comprise various protocol layers for structuring and controlling the trace data from the single trace source 104a. Layer 1 (401) may comprise physical connections, such as, TPIU pins, USB pins, etc. Layer 2 (403) may comprise an optional trace formatter (e.g., Coresight trace formatter protocol). Layer 3 (405) may comprise trace packets supporting protocols, such as, for example, ARM ETM, PFT, and MIPI STPv2. Layer 4 (407) may comprise diagnostic packets (e.g., MIPI OST).

The trace protocol stack 400 may further comprise a specially-configured “layer 2” periodic trace control packet for enabling the trace reassembly module 114 to de-interleave trace dumps 110a and 110b containing the respective trace data originated from the single trace source 104a. As illustrated in FIG. 4, the periodic trace control packet may comprise a periodic parser de-interleave control packet 409 defining a header 411 and one or more control or data for programmatically supporting any desirable interleave/de-interleave scheme. The header 411 may identify a special packet type. A control or data field 413 may contain a sequence number associated with a particular de-interleaving scheme. The sequence number may support a sufficient number of bits to prevent rollover. A control or data field 415 may contain an interleave amount that specifies an order for the de-interleaving scheme (e.g., 1212 . . . ). A control or data field 417 may contain an interleave amount that specifies an amount of bytes associated with the interleave number. One of ordinary skill in the art will appreciate that alternative trace control packet structures and interleaving schemes may be used as desired. For example, in an embodiment, the trace parser 112 may be configured with or otherwise access the interleave order and/or amount (e.g., a command line option or other user interface to the trace parser 112) rather than being included in the periodic parser de-interleave control packet 409.

Referring again to FIG. 3, at block 302, the trace subsystem 106 and/or the trace sources 104 may configure the trace data as described above. At block 304, the trace data originated by the single trace source 104a is sent to a plurality of trace sinks 109. In an embodiment, the trace subsystem 106 may support the ARM architecture and a specially-configured ATB replicator may be configured to receive the trace data and output the trace data according to the trace control packet data. For example, a first portion may be sent, via a connection 203 (FIG. 2), to a first trace sink 109a associated with a first interleave number (control field 415). A second portion may be sent, via a connection 205, to a second trace sink 109b associated with a second interleave number (control field 415). As known in the art, the ATB replicator enables the replication of a single trace stream to two output ATB trace streams that may be further replicated to a plurality of trace sinks.

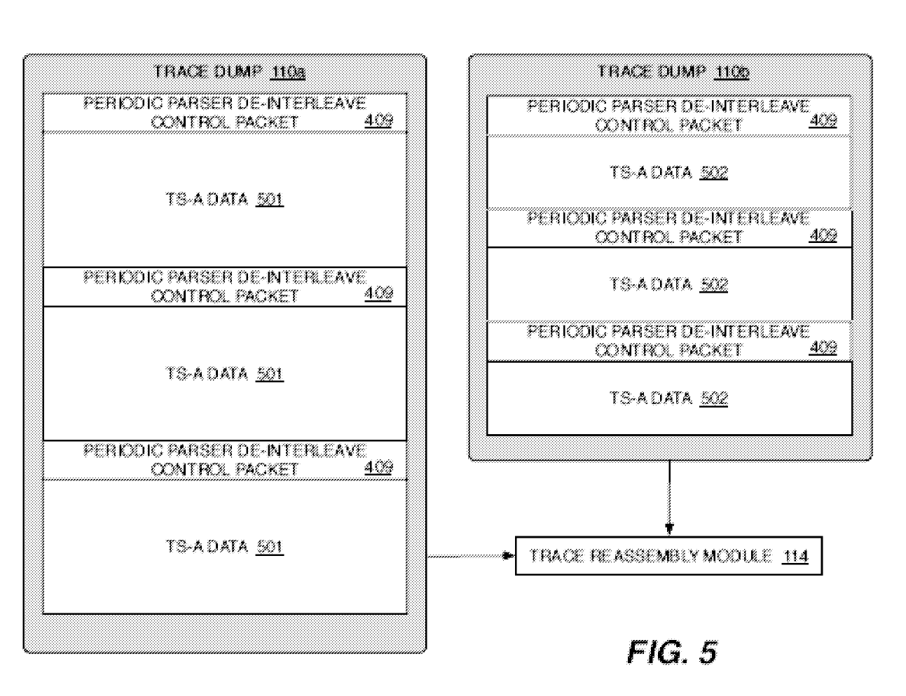

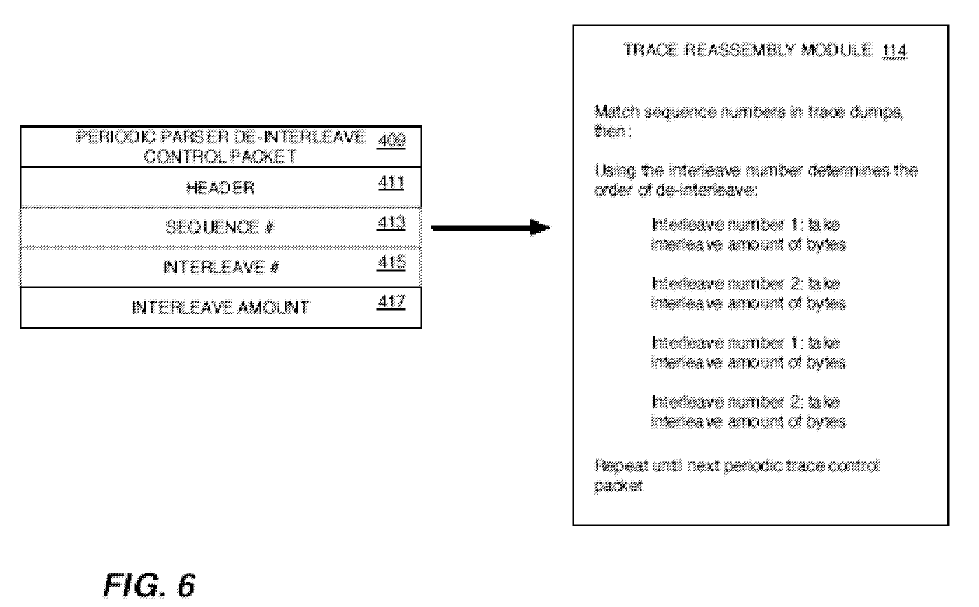

As illustrated in FIG. 5, a first portion 501 of the trace data may be dumped to trace dump 110a and a second portion 502 may be dumped to trace dump 110b, in accordance with the periodic parser de-interleave control packets 409. Trace dumps 110a and 110b may comprise any desirable memory, storage, files, etc. Referring again to the flowchart of FIG. 3, at block 306, the trace data is reassembled, reconstructed, or de-interleaved from the trace dumps 110a and 110b. As illustrated in FIGS. 5 & 6, the trace reassembly module 114 interfaces with the trace dumps 110a and 110b. The trace dumps 110a and 110b may be processed separately, substantially in parallel, or otherwise. One of ordinary skill with appreciate that the periodic parser de-interleave control packets 409 enable the trace reassembly module 114 to reconstruct the trace data by matching sequence numbers (control field 413) in the trace dumps 110a and 110b. Using the interleave number, the trace reassembly module 114 determines the order of the de-interleave. As illustrated in the embodiment of FIG. 6, the order of the de-interleave may alternate between interleave number 1 and interleave number 2, although other interleave ratios and schemes may be used. For each interleave number, the trace reassembly module 114 takes the interleave amount specified in control field 417. This process may be repeated until the next periodic parser de-interleave control packet is read from the trace dump file.

FIG. 7 illustrates the system 100 described above incorporated in an exemplary portable computing device (PCD) 700. It should be appreciated that some components of system 100 are included on the SoC 322 while others may reside off-chip, as described above. For example, the trace subsystem 106 and the trace sources 104 may be included on the SoC 322 while the trace sinks 109, trace dumps 110, and trace parser 112 may or may not be included on the SoC 322. The SoC 322 may comprise any embedded system that may be separately manufactured and incorporated into designs for the portable computing device 700.

As shown, the PCD 700 includes an SoC 322 that includes a multicore CPU 402A. The multicore CPU 402A may include a zeroth core 410, a first core 412, and an Nth core 414. A display controller 328 and a touch screen controller 330 may be coupled to the GPU 106. In turn, the touch screen display 108 external to the SoC 322 may be coupled to the display controller 328 and the touch screen controller 330.

FIG. 7 further shows that a video encoder 334, e.g., a phase alternating line (PAL) encoder, a sequential color a memoire (SECAM) encoder, or a national television system(s) committee (NTSC) encoder, is coupled to the multicore CPU 402A. Further, a video amplifier 336 is coupled to the video encoder 334 and the touch screen display 108. Also, a video port 338 is coupled to the video amplifier 336. As shown in FIG. 7, a universal serial bus (USB) controller 340 and other trace sinks 109 and trace dumps 110 may be coupled to the multicore CPU 402A. Also, a USB port 342 is coupled to the USB controller 340. Memory 404A and a subscriber identity module (SIM) card 346 may also be coupled to the multicore CPU 402A.

Further, as shown in FIG. 7, a digital camera 348 may be coupled to the multicore CPU 402A. In an exemplary aspect, the digital camera 348 is a charge-coupled device (CCD) camera or a complementary metal-oxide semiconductor (CMOS) camera.

As further illustrated in FIG. 7, a stereo audio coder-decoder (CODEC) 350 may be coupled to the multicore CPU 402A. Moreover, an audio amplifier 352 may coupled to the stereo audio CODEC 350. In an exemplary aspect, a first stereo speaker 354 and a second stereo speaker 356 are coupled to the audio amplifier 352. FIG. 7 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 7 further illustrates that a radio frequency (RF) transceiver 368 may be coupled to the multicore CPU 402A. An RF switch 370 may be coupled to the RF transceiver 368 and an RF antenna 372. As shown in FIG. 7, a keypad 204 may be coupled to the multicore CPU 402A. Also, a mono headset with a microphone 376 may be coupled to the multicore CPU 402A. Further, a vibrator device 378 may be coupled to the multicore CPU 402A.

FIG. 7 also shows that a power supply 380 may be coupled to the SoC 322. In a particular aspect, the power supply 380 is a direct current (DC) power supply that provides power to the various components of the PCD 700 that require power. Further, in a particular aspect, the power supply is a rechargeable DC battery or a DC power supply that is derived from an alternating current (AC) to DC transformer that is connected to an AC power source.

FIG. 7 further indicates that the PCD 700 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 7, the touch screen display 108, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

In a particular aspect, one or more of the method steps described herein may be stored in the memory 404A as computer program instructions, such as the modules described above in connection with the system 100 as illustrated in FIG. 1.

These instructions may be executed by the multicore CPU 402A in combination or in concert with the memory channel optimization module 102 to perform the methods described herein. Further, the multicore CPU 402A, the trace subsystem 106, the single source multi-sink control module 105, the trace reassembly module 114, memory 404A of the PCD 700, or a combination thereof may serve as a means for executing one or more of the method steps described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

What is claimed is:

1. A method for managing trace data in a portable computing device, the method comprising:
configuring trace data from a single trace source on a system-on-chip for trace capture at a plurality of trace sinks;
sending the trace data from the single trace source to the plurality of trace sinks; and
reassembling the trace data originated by the single trace source from the plurality of trace sinks.

2. The method of claim 1, wherein the sending the trace data from the single trace source to the plurality of trace sinks comprises:
sending a first portion of the trace data to a first trace sink; and
sending a second portion of the trace data to a second trace sink.

3. The method of claim 2, wherein the first trace sink comprises a high bandwidth trace sink and the second trace sink comprises a relatively lower bandwidth trace sink.

4. The method of claim 1, wherein one or more of the plurality of trace sinks comprise a trace protocol interface unit (TPIU), a universal serial bus (USB), a double data rate (DDR) bus, a peripheral component interconnect express (PCIe), or a debugger.

5. The method of claim 1, wherein one or more of the plurality of trace sinks reside off the system-on-chip.

6. The method of claim 1, wherein the sending the trace data from the single trace source to the plurality of trace sinks comprises a programmable replicator.

7. The method of claim 1, wherein the trace data is sent to the plurality of trace sinks according to an interleave algorithm.

8. The method of claim 7, wherein the reassembling the trace data from the plurality of trace sinks comprises a trace parser configured to de-interleave the trace data from a plurality of trace files.

9. The method of claim 1, wherein the trace data comprises a periodic trace control packet configured to enable a trace parser to reassemble the trace data from a plurality of trace files associated with the trace sinks according to a de-interleaving scheme.

10. The method of claim 9, wherein the periodic trace control packet comprises:
a header for identifying a packet type;
a first data field containing a sequence number associated with the de-interleaving scheme;
a second data field containing an interleave number that specifies an order for the de-interleaving scheme;
a third data field containing an interleave amount that specifies an amount of bytes associated with the interleave number.

11. A system for managing trace data in a portable computing device, the system comprising:
means for configuring trace data from a single trace source on a system-on-chip for trace capture at a plurality of trace sinks;
means for sending the trace data from the single trace source to the plurality of trace sinks; and
means for reassembling the trace data originated by the single trace source from the plurality of trace dumps.

12. The system of claim 11, wherein the means for sending the trace data from the single trace source to the plurality of trace sinks comprises:
means for sending a first portion of the trace data to a first trace sink; and
means for sending a second portion of the trace data to a second trace sink.

13. The system of claim 12, wherein the first trace sink comprises a high bandwidth trace sink and the second trace sink comprises a relatively lower bandwidth trace sink.

14. The system of claim 11, wherein one or more of the plurality of trace sinks comprise a trace protocol interface unit (TPIU), a universal serial bus (USB), a double data rate (DDR) bus, a peripheral component interconnect express (PCIe), or a debugger.

15. The system of claim 11, wherein one or more of the plurality of trace sinks reside off the system-on-chip.

16. The system of claim 11, wherein the means for sending the trace data from the single trace source to the plurality of trace sinks comprises a programmable replicator.

17. The system of claim 11, wherein the trace data is sent to the plurality of trace sinks according to an interleave algorithm.

18. The system of claim 17, wherein the means for reassembling the trace data from the plurality of trace sinks comprises a trace parser configured to de-interleave the trace data from a plurality of trace files.

19. The system of claim 11, wherein the trace data comprises a periodic trace control packet configured to enable a trace parser to reassemble the trace data from a plurality of trace files associated with the trace sinks according to a de-interleaving scheme.

20. The system of claim 19, wherein the periodic trace control packet comprises:
a header for identifying a packet type;
a first data field containing a sequence number associated with the de-interleaving scheme;
a second data field containing an interleave number that specifies an order for the de-interleaving scheme;
a third data field containing an interleave amount that specifies an amount of bytes associated with the interleave number.

21. A system for managing trace data in a portable computing device, the system comprising:
a system-on-chip comprising:
a plurality of trace sources for originating corresponding trace data; and
a trace subsystem configured to receive and dump the trace data from one of the trace sources to a plurality of trace sinks; and
a trace parser configured to reconstruct the trace data dumped to the plurality of trace sinks.

22. The system of claim 21, wherein the trace subsystem is configured to send a first portion of the trace data to a first of the plurality of trace sinks and send a second portion of the trace data to a second of the plurality of trace sinks.

23. The system of claim 22, wherein the first trace sink comprises a high bandwidth trace sink and the second trace sink comprises a relatively lower bandwidth trace sink.

24. The system of claim 21, wherein one or more of the plurality of trace sinks comprise a trace protocol interface unit (TPIU), a universal serial bus (USB), a double data rate (DDR) bus, a peripheral component interconnect express (PCIe), or a debugger.

25. The system of claim 21, wherein one or more of the plurality of trace sinks reside off the system-on-chip.

26. The system of claim 21, wherein the trace system comprises a programmable replicator.

27. The system of claim 21, wherein the trace data is dumped to the plurality of trace sinks according to an interleave algorithm.

28. The system of claim 27, wherein the trace parse is configured to de-interleave the trace data from a plurality of trace files.

29. The system of claim 21, wherein the trace data comprises a periodic trace control packet configured to enable the trace parser to reconstruct the trace data from a plurality of trace files associated with the trace sinks according to a de-interleaving scheme.

30. The system of claim 29, wherein the periodic trace control packet comprises:
a header for identifying a packet type;
a first data field containing a sequence number associated with the de-interleaving scheme;
a second data field containing an interleave number that specifies an order for the de-interleaving scheme;
a third data field containing an interleave amount that specifies an amount of bytes associated with the interleave number.

31. The system of claim 21, wherein the system-on-chip is configured for use in a portable computing device.

32. A computer program for managing trace data in a portable computing device, the computer program embodied in a computer-readable medium for execution by a processor, the computer program comprising logic configured to:
configure trace data from a single trace source on a system-on-chip for trace capture at a plurality of trace sinks;
send the trace data originated from the single trace source to the plurality of trace sinks; and
reassemble the trace data originated by the single trace source from the plurality of trace sinks.

33. The computer program of claim 32, wherein a first portion of the trace data is sent to a first trace sink and a second portion of the trace data is sent to the second trace sink.

34. The computer program of claim 33, wherein the first trace sink comprises a high bandwidth trace sink and the second trace sink comprises a relatively lower bandwidth trace sink.

35. The computer program of claim 32, wherein one or more of the plurality of trace sinks comprise a trace protocol interface unit (TPIU), a universal serial bus (USB), a double data rate (DDR) bus, a peripheral component interconnect express (PCIe), or a debugger.

36. The computer program of claim 32, wherein one or more of the plurality of trace sinks reside off the system-on-chip.

37. The computer program of claim 32, wherein the logic configured to send the trace data from the single trace source to the plurality of trace sinks comprises a programmable replicator.

38. The computer program of claim 32, wherein the trace data is sent to the plurality of trace sinks according to an interleave algorithm.

39. The computer program of claim 38, wherein the logic configured to reassemble the trace data from the plurality of trace sinks comprises a logic configured to de-interleave the trace data from a plurality of trace files.

40. The computer program of claim 32, wherein the trace data comprises a periodic trace control packet configured to enable a trace parser to reassemble the trace data from a plurality of trace files associated with the trace sinks according to a de-interleaving scheme.

41. The computer program of claim 40, wherein the periodic trace control packet comprises:
a header for identifying a packet type;
a first data field containing a sequence number associated with the de-interleaving scheme;
a second data field containing an interleave number that specifies an order for the de-interleaving scheme;
a third data field containing an interleave amount that specifies an amount of bytes associated with the interleave number.
